(19) United States
(12) Patent Application Publication
(10) Pub. No.: US 2016/0057753 A1
(43) Pub. Date: Feb. 25, 2016

(54) REDUCED DMRS CONFIGURATION AND METHOD AND APPARATUS FOR ADAPTIVELY SELECTING DMRS CONFIGURATION

(71) Applicant: ALCATEL LUCENT, Paris (FR)

(72) Inventors: Yubo Yang, Shanghai (CN); Xudong Zhu, Shanghai (CN); Jin Liu, Shanghai (CN); Qingchuan Zhang, Shanghai (CN)

(73) Assignee: ALCATEL LUCENT, Boulogne Billancourt (FR)

(21) Appl. No.: 14/780,876

(22) PCT Filed: Mar. 18, 2014
(86) PCT No.: PCT/IB2014/000573

§ 371 Date: Sep. 28, 2015

(30) Foreign Application Priority Data
Mar. 29, 2013 (CN) 201310109397.3

(51) Int. Cl. H04W 72/04; H04L 5/00; H04L 12/26

(52) U.S. Cl. CPC H04W 72/0446; H04L 43/16; H04L 5/0048

(57) ABSTRACT

The present invention provides a reduced DMRS configuration and a method and apparatus for adaptively selecting a DMRS configuration. The method comprises: estimating channel change with respect to a target UE; and selecting one of a normal DMRS configuration or a reduced DMRS configuration for the target UE based on the estimated channel change, wherein, in the normal DMRS configuration, a DMRS symbol is assigned to each time slot, while in the reduced DMRS configuration, a DMRS symbol is assigned to each subframe.

### FIELD OF THE INVENTION

The present invention generally relates to the field of wireless communication, and more specifically, relates to a reduced DMRS (Demodulation Reference Signal) configuration, and a method and apparatus for adaptively selecting a DMRS configuration.

### BACKGROUND OF THE INVENTION

In a 3^{rd} Generation Partnership Project (3GPP) Long-Term Evolution (LTE) system, a base station centralized scheduling manner is adopted to control physical uplink shared channel (PUSCH) transmission of user equipments (UEs). A base station sends uplink scheduling information for the PUSCH and a Physical Uplink Control Channel (PUCCH) to the UEs over a physical downlink control channel (PDCCH), wherein the uplink scheduling information comprises DMRS-related information.

In a frequency-division duplexing (FDD) frame structure defined in the LTE system, a wireless frame includes 10 subframes, each subframe including 2 timeslots, and each time slot including 6 symbols (in the case of an extended cyclic prefix (CP)) or 7 symbols (in the case of a normal cyclic prefixes (CP)).

In a normal DMRS configuration, the DMRS occupies one symbol in each timeslot; therefore, transmission of the DMRS symbol will consume 14% (in the case of a normal CP) or 18% (in the case of an extended CP) of the uplink bandwidth.

Besides, for a small cell, small cell enhancement has been regarded by 3GPP as a prospective technology for enhancing system performance and has been recommended as a Study Item in Rel-12. As stated in the 3GPP TR 36.932, low-mobility UE is only considered for the indoor environment, while for an outdoor environment, a medium-mobility UE is further considered. For a low-mobility UE, since the coherence time is relatively long, it becomes unnecessary for the DMRS to occupy a symbol in each time slot.

### SUMMARY OF THE INVENTION

In view of the above problems, the present invention provides a reduced DMRS configuration and a solution for adaptively selecting a DMRS configuration to enhance frequency spectrum efficiency.

According to one aspect of the present invention, there is provided with a method for adaptively selecting a DMRS configuration, comprising: estimating channel change with respect to a target UE; and selecting one of a normal DMRS configuration or a reduced DMRS configuration for the target UE based on the estimated channel change, wherein in the normal DMRS configuration, a DMRS symbol is assigned to each time slot, and in the reduced DMRS configuration, a DMRS symbol is assigned to each subframe.

According to another aspect of the present invention, there is provided with an apparatus for adaptively selecting a DMRS configuration, comprising: a channel change estimating unit configured to estimate channel change with respect to a target UE; and a DMRS configuration selecting unit configured to select one of a normal DMRS configuration or a reduced DMRS configuration for the target UE based on the estimated channel change, wherein in the normal DMRS configuration, a DMRS symbol is assigned to each time slot, and in the reduced DMRS configuration, a DMRS symbol is assigned to each subframe.

By virtue of the solutions of the present invention, spectrum efficiency is improved by adaptively selecting a DMRS configuration based on a channel change condition of a target UE, which enhances the system throughput.

### BRIEF DESCRIPTION OF THE DRAWINGS

The present invention will be better understood and other objectives, details, features, and advantages of the present invention will become more obvious through the following depiction of the preferred embodiments with reference to the accompanying drawings, in which

FIG. 1 shows a schematic diagram of a normal DMRS configuration;

FIG. 2 shows a schematic diagram of a reduced DMRS configuration according to the embodiments of the present invention;

FIG. 3 shows a flow chart of a method for adaptively selecting a DMRS configuration according to the embodiments of the present invention;

FIG. 4 shows a detailed flow chart of a method for adaptively selecting a DMRS configuration according to the embodiments of the present invention;

FIG. 5 shows a schematic diagram of an apparatus for adaptively selecting a DMRS configuration according to the embodiments of the present invention;

FIG. 6 shows a network topology used in the simulations performed according to the embodiments of the present invention; and

FIGS. 7 and 8 illustrate simulation results under different UE speeds, respectively.

In all of the accompanying drawings, like reference numbers indicate same, like or corresponding features or functions.

### DETAILED DESCRIPTION OF THE INVENTION

Some preferred embodiments will be described in more detail with reference to the accompanying drawings, in which the preferred embodiments of the present disclosure have been illustrated. However, it's to be understood that the present disclosure may be implemented in various manners without being limited to the embodiments disclosed herein. On the contrary, those embodiments are provided for the thorough and complete understanding of the present disclosure, and completely conveying the scope of the present disclosure to those skilled in the art.

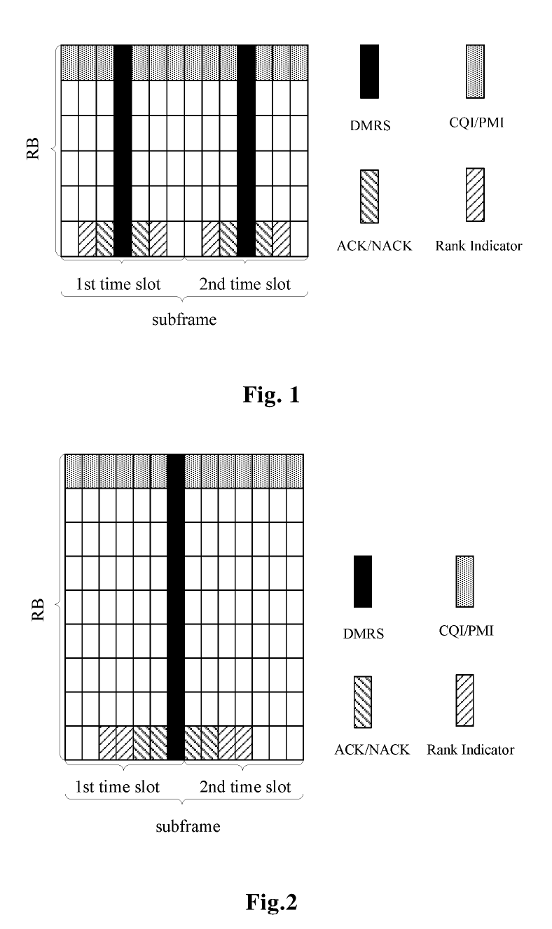

Uplink DMRSs are used for channel estimation for coherence demodulation of the PUSCH and PUCCH so as to resolve the channel estimation matrix and for data decoding for PUSCH and PUCCH. Due to the importance of low cubic metric and the corresponding high power-amplifier efficiency for uplink transmission, reference signals shall not be transmitted in parallel with other uplink transmission from the same terminal. Therefore, currently, 2 OFDM symbols in a subframe are exclusively used for DMRS transmission for PUSCH, as shown in FIG. 1. FIG. 1 shows a schematic diagram of a normal DMRS configuration. As shown in FIG. 1, in a normal DMRS configuration in the case of a normal CP, the DMRS symbol is located at a middle symbol (i.e., the fourth symbol) of 7 symbols of each timeslot. Besides, in the normal DMRS configuration in the case of an extended CP, the DMRS symbol is located at the third symbol (not shown) of 6 symbols of each time slot. Hereinafter, depiction will be made with the case of a normal CP as an example. However, those skilled in the art would appreciate that the solution disclosed by the present invention is totally applicable for the extended CP.

Furthermore, the present disclosure also takes a FDD frame structure as an example. However, those skilled in the art would appreciate that the solution disclosed by the present invention is completely suitable for a time-division duplexing (TDD) frame structure.

When the UE transmits L1/L2 signaling over PUSCH, a hybrid automatic repeat request (HARQ) acknowledgement and channel state report are also transmitted over the PUSCH. FIG. 1 also shows other signaling configurations besides the DMRS symbols in the PUSCH, such as HARQ acknowledgement (ACK/NACK) and channel state report (CQI/PMI), etc. Since HARQ acknowledgement is very important for the proper operation of downlink, the more the HARQ is close to the DMRS symbol, the better the quality of channel estimation is. For example, the HARQ acknowledgement may be transmitted in immediately adjacent to the DMRS symbol, as shown in FIG. 1.

As stated above, in the 3GPP TR 36.932, only low-mobility UEs are only considered for the indoor environment, while for an outdoor environment, medium-mobility UEs are further considered. For low-mobility UEs, since the coherence time is relatively long, it becomes unnecessary for the DMRS to occupy a symbol in each time slot (which would consume 14% or 18% of the uplink bandwidth). In order to utilize this feature, a reduced DMRS configuration is proposed for uplink LTE transmission.

FIG. 2 shows a diagram of a reduced DMRS configuration according to the embodiments of the present invention. As shown in FIG. 2, for each subframe, the number of DMRS symbols for uplink transmission is reduced from 2 to 1. That is to say, each subframe, rather than each time slot, is assigned with a DMRS symbol. It may be seen that in this way, signaling overhead of the DMRS symbols is reduced half, which will only consume 7% or 9% of the uplink bandwidth.

Further, by setting the position of the DMRS symbol closer to the middle of the subframe, the channel estimation performed based on the DMRS symbol would be more accurate than the channel estimation performed when the DMRS symbol is located in the middle of the first or second time slot or located at other positions in the subframe. In one preferred embodiment, the DMRS symbol is located at the last symbol of the first time slot of the subframe, as shown in FIG. 2. In another preferred embodiment, the DMRS symbol is located at the first symbol of the second time slot of the subframe.

Besides, as stated above, when the UE transmits L1/L2 signaling over PUSCH, the HARQ acknowledgement should still be placed closer to the DMRS symbol, as shown in FIG. 2.

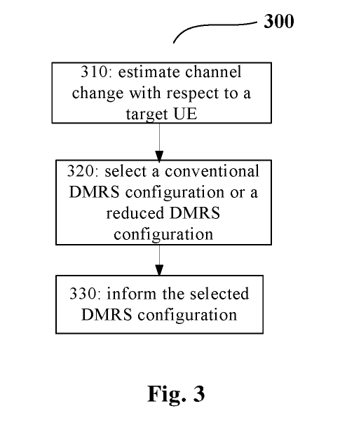

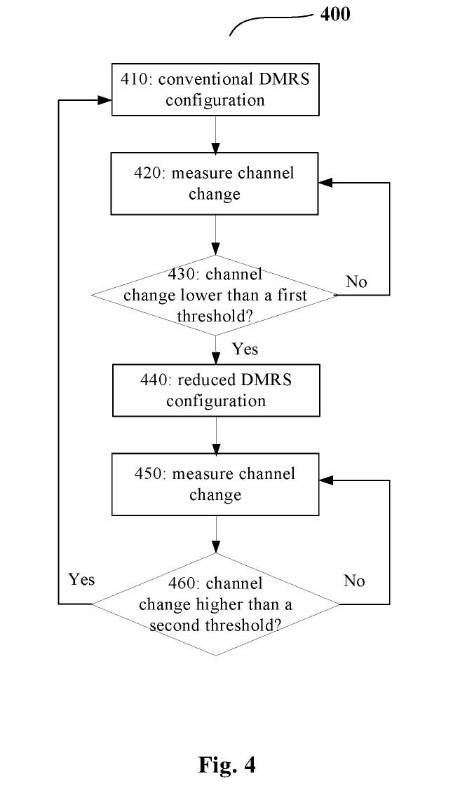

FIG. 3 shows a flow chart of a method 300 for adaptively selecting a DMRS configuration according to the embodiments of the present invention. Since medium or high-mobility UEs may also be in an outdoor small cell, PUSCH may be configured by adaptively selecting a normal DMRS configuration or a reduced DMRS configuration. Since the UE's mobility is stable within a short time, the selected DMRS configuration may be indicated through high-layer signaling.

As shown in FIG. 3, at step 310 of the method 300, a base station estimates channel change with respect to a target UE.

Next, at step 320, the base station selects a normal DMRS configuration or a reduced DMRS configuration for the target UE based on the channel change estimated in step 310. Here, in the normal DMRS configuration, a DMRS symbol is assigned to each time slot (as shown in FIG. 1), while in the reduced DMRS configuration, a DMRS symbol is assigned to each subframe (as shown in FIG. 2).

In one embodiment, the method 300 may further comprise a step 330, where the base station indicates the selected DMRS configuration to the target UE through higher-layer signaling so as to be used for subsequent uplink transmission.

In one implementation, in the reduced DMRS configuration, the assigned DMRS symbol is located at the middle of the subframe.

In one implementation, in the reduced DMRS configuration, the assigned DMRS symbol is located at the last symbol of the first time slot of the subframe.

In one implementation, in the reduced DMRS configuration, the assigned DMRS symbol is located at the first symbol of the second time slot of the subframe.

In one implementation, in the normal DMRS configuration, channel change between a first time slot and a second time slot of the subframe is estimated.

In one implementation, in the reduced DMRS configuration, channel change between a first subframe and a second subframe of two consecutive subframes is estimated.

In one implementation, the channel change is estimated using one of channel matrix estimation, Doppler estimation, or UE speed estimation.

In one implementation, in the case of currently using the normal DMRS configuration, if the estimated channel change is lower than a first predetermined threshold, the reduced DMRS configuration will be selected for subsequent uplink transmission.

In one implementation, in the case of currently using the reduced DMRS configuration, if the estimated channel change is higher than a second predetermined threshold, the normal DMRS configuration will be selected for subsequent uplink transmission.

FIG. 4 shows a detailed flow chart of a method 400 for adaptively selecting a DMRS configuration according to the embodiments of the present invention.

As shown in FIG. 4, method 400 starts at step 410, where a base station configures a PUSCH for uplink transmission of a target UE with a normal DMRS configuration at an initial stage.

Next, at step 420, the base station estimates channel change condition under the normal DMRS configuration. In one embodiment, the base station uses a channel matrix estimation method to estimate the channel change between two time slots of a subframe as:

$${E}_{s \_ H} = \frac{‖ {H}_{s 1} - {H}_{s 2} ‖}{‖ {H}_{s 1} ‖} , \qquad ( 1 )$$

where Eₛ_{_{—}}_{H} is the estimated channel change, Hₛ₁ and Hₛ₂ are channel matrixes for the first time slot and second time slot of the subframe, and ∥•∥ indicates norm of a matrix.

Next, at step 430, the base station compares the estimated channel change E_{H} with a first predetermined threshold λ₁. When E_{H} is lower than the first predetermined threshold λ₁, the base station indicates the target UE through higher-layer signaling to use the reduced DMRS configuration in the subsequent uplink transmission, as shown in step 440. When E_{H} is not lower than the first predetermined threshold λ₁, the method 400 returns to step 420, where the base station continues estimation of channel change in subframes.

In other embodiments, the base station may also use the Doppler estimation or UE speed estimation to estimate the channel change condition, and compare it with a corresponding threshold to determine whether to switch to a reduced DMRS configuration.

In one embodiment, at step 440, the base station periodically schedule 2 or more consecutive subframes to the target UE for uplink transmission according to the reduced DMRS configuration.

Next, at step 450, the base station estimates channel change condition under the reduced DMRS configuration. In one embodiment, the base station uses a channel matrix estimation method to estimate the channel change between the scheduled 2 consecutive subframes as:

$${E}_{sf \_ H} = \frac{‖ {H}_{sf 1} - {H}_{sf 2} ‖}{‖ {H}_{sf 1} ‖} , \qquad ( 2 )$$

where E_{sf}_{_{—}}_{H} is the estimated channel change, H_{sf1} and H_{sf2} are channel matrixes for the first subframe and second subframe of the 2 consecutive subframes, and ∥•∥ illustrates norm of a matrix.

Next, at step 460, the base station compares the estimated channel change E_{sf}_{_{—}}_{H} with a second predetermined threshold λ₂. When E_{sf}_{_{—}}_{H} is higher than the second predetermined threshold λ₂, the base station indicates the target UE to use the normal DMRS configuration in the subsequent uplink transmission through higher-layer signaling, and then the method 400 returns to step 410. When E_{sf}_{_{—}}_{H} is not higher than the second predetermined threshold λ₂, the method 400 returns to step 450, where the base station continues estimation of channel change of two consecutive subframes.

Those skilled in the art may understand that the first predetermined threshold λ₁ and the second predetermined threshold λ₂ may be selected according to different operation conditions and/or QoS requirements.

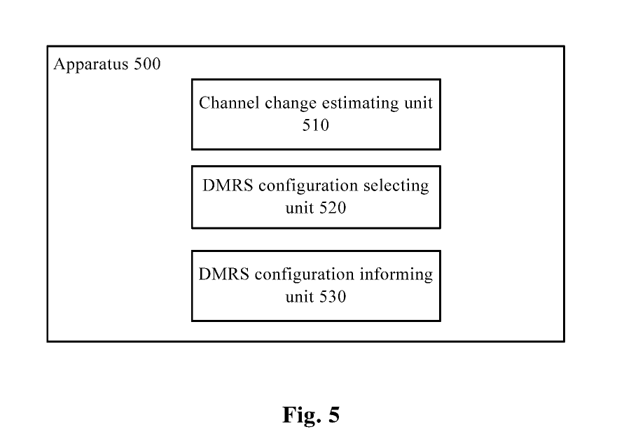

FIG. 5 shows a schematic diagram of an apparatus 500 for adaptively selecting a DMRS configuration according to the embodiments of the present invention. The apparatus 500 for example may be implemented in a base station or by the base station.

As shown, the apparatus 500 comprises: a channel change estimating unit 510 configured to estimate channel change with respect to a target UE, and a DMRS configuration selecting unit 520 configured to select one of a normal DMRS or a reduced DMRS for the target UE based on the estimated channel change. Here, in the normal DMRS configuration, a DMRS symbol is assigned to each time slot (as shown in FIG. 1), while in the reduced DMRS configuration, a DMRS symbol is assigned to each subframe (as shown in FIG. 2).

In one embodiment, the apparatus 500 may further comprise a DMRS configuration notifying unit 530 configured to indicate the selected DMRS configuration to the target UE through higher-layer signaling so as to be used for subsequent uplink transmission.

In one implementation, in the reduced DMRS configuration, the assigned DMRS symbol is located at the middle of the subframe.

In one implementation, in the reduced DMRS configuration, the assigned DMRS symbol is located at the last symbol of the first time slot of the subframe.

In one implementation, in the reduced DMRS configuration, the assigned DMRS symbol is located at the first symbol of the second time slot of the subframe.

In one implementation, the channel change estimating unit is configured to estimate, in the normal DMRS configuration, channel change between a first time slot and a second time slot of the subframe.

In one implementation, the channel change estimating unit is configured to estimate, in the reduced DMRS configuration, channel change between a first subframe and a second subframe of two consecutive subframes.

In one implementation, the channel change estimating unit is configured to estimate the channel change using Doppler estimation or UE speed estimation.

In one implementation, the DMRS configuration selecting unit is configured to select the reduced DMRS configuration for subsequent uplink transmission if the estimated channel change is lower than a first predetermined threshold in the case of currently using the normal DMRS configuration.

In one implementation, the DMRS configuration selecting unit is configured to select the normal DMRS configuration for subsequent uplink transmission if the estimated channel change is higher than the second predetermined threshold in the case of currently using a reduced DMRS configuration.

In the present disclosure, according to the context of using the term of “base station”, it may refer to the coverage of a base station and/or a base station or a base station subsystem serving the coverage. In the present disclosure, according to the context, the term “base station” may be interchangeably used with “cell,” “Node B,” “eNode B,” etc.

By virtue of the reduced DMRS configuration for uplink transmission as proposed in the present invention, in the case of a small cell (or generally in the case of a lower UE mobility), the DMRS signaling overhead may be reduced by 50%, thereby enhancing the spectrum efficiency and system throughput, which is validated through simulation.

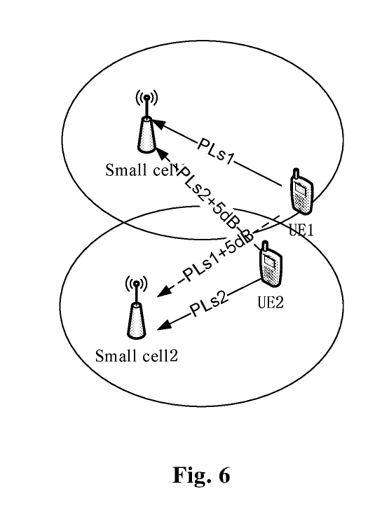

Table 1 shows a hypothetical condition for simulation, wherein the network topology is as shown in FIG. 6.

TABLE 1
Hypothetical Simulation Condition for Uplink Transmission

| | | |
|---|---|---|
| System | Network Topology | As shown in FIG. 6 |
| Parameter | Carrier frequency | 2.0 GHz |
| Channel | Channel model | SCME |
| Parameter | | the delay mode may refer to |
| | | 3GPP TS 36.101 |
| | | Table B.2.1-2 (EPA Model) |
| | MIMO | 1 × 2 with low correlation |
| | Configuration | see 3GPP TS 36.101 B.2.3.2 |
| UE | MCS | Fixed as 16QAM ⅓ |
| | HARQ | Yes |
| | Speed | 0 km/h, 15 km/h |
| | DMRS | Without coordination |

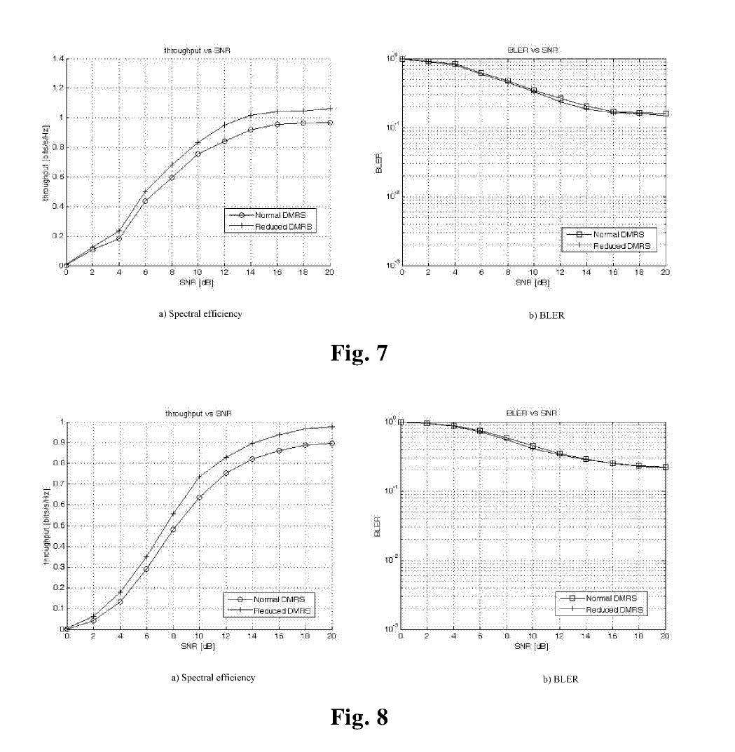

FIGS. 7 and 8 illustrate the simulation results of the UE at a speed of 0 kn/h and 15 km/h, respectively. It is seen that with the reduced DMRS configuration, in the case of the UE low-mobility, the throughput increases significantly, while the block error ratio (BLER) is not affected significantly.

Here, the method as disclosed has been described with reference to the accompanying drawings. However, it should be appreciated that the sequence of the steps as illustrated in the figures and described in the description are only illustrative, and without departing from the scope of the claims, these method steps and/or actions may be executed in a different sequence, without being limited to the specific sequence as shown in the drawings and described in the description.

In one or more exemplary designs, the functions of the present application may be implemented using hardware, software, firmware, or any combinations thereof. In the case of implementation with software, the functions may be stored on a computer readable medium as one or more instructions or codes, or transmitted as one or more instructions or codes on the computer readable medium. The computer readable medium comprises a computer storage medium and a communication medium. The communication medium includes any medium that facilitates transmission of the computer program from one place to another. The storage medium may be any available medium accessible to a general or specific computer. The computer-readable medium may include, for example, but not limited to, RAM, ROM, EEPROM, CD-ROM or other optical disc storage devices, magnetic disk storage devices, or other magnetic storage devices, or any other medium that carries or stores desired program code means in a manner of instructions or data structures accessible by a general or specific computer or a general or specific processor. Furthermore, any connection may also be considered as a computer-readable medium. For example, if software is transmitted from a website, server or other remote source using a co-axial cable, an optical cable, a twisted pair wire, a digital subscriber line (DSL), or radio technologies such as infrared, radio or microwave, then the co-axial cable, optical cable, twisted pair wire, digital subscriber line (DSL), or radio technologies such as infrared, radio or microwave are also covered by the definition of medium.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any normal processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The above depiction of the present disclosure is to enable any of those skilled in the art to implement or use the present invention. For those skilled in the art, various modifications of the present disclosure are obvious, and the general principle defined herein may also be applied to other transformations without departing from the spirit and protection scope of the present invention. Thus, the present invention is not limited to the examples and designs as described herein, but should be consistent with the broadest scope of the principle and novel characteristics of the present disclosure.

What is claimed is:

1. A method for adaptively selecting a demodulation reference signal (DMRS) configuration, comprising:
estimating channel change with respect to a target user equipment (UE); and
selecting one of a normal DMRS configuration or a reduced DMRS configuration for the target UE based on the estimated channel change,
wherein, in the normal DMRS configuration, a DMRS symbol is assigned to each time slot, while in the reduced DMRS configuration, a DMRS symbol is assigned to each subframe.

2. The method according to claim 1, wherein in the reduced DMRS configuration, the assigned DMRS symbol is located at the middle of the subframe.

3. The method according to claim 2, wherein the assigned DMRS symbol is located at a last symbol of a first time slot of the subframe.

4. The method according to claim 2, wherein the assigned DMRS symbol is located at a first symbol of a second time slot of the subframe.

5. The method according to claim 1, wherein estimating the channel change comprises: in the normal DMRS configuration, estimating channel change between a first time slot and a second time slot of the subframe.

6. The method according to claim 1, wherein estimating the channel change comprises: in the reduced DMRS configuration, estimating channel change between a first subframe and a second subframe of two consecutive subframes.

7. The method according claim 1, wherein estimating channel change comprises: estimating channel change using one of channel matrix estimation, Doppler estimation, or UE speed estimation.

8. The method according to claim 1, wherein selecting one of a normal DMRS configuration or a reduced DMRS configuration for the target UE based on the estimated channel change comprises:
in case of currently using the normal DMRS configuration, if the estimated channel change is lower than a first predetermined threshold, selecting the reduced DMRS configuration for subsequent uplink transmission.

9. The method according to claim 1, wherein selecting one of a normal DMRS configuration or a reduced DMRS configuration for the target UE based on the estimated channel change comprises:
in case of currently using the reduced DMRS configuration, if the estimated channel change is higher than a second predetermined threshold, selecting the normal DMRS configuration for subsequent uplink transmission.

10. The method according to claim 1, further comprising:
indicating the selected DMRS configuration to the target UE through higher-level signaling so as to be used for subsequent uplink transmission.

11. An apparatus for adaptively selecting a demodulation reference signal (DMRS) configuration, comprising:
a channel change estimating unit configured to estimate channel change with respect to a target user equipment (UE); and
a DMRS configuration selecting unit configured to select one of a normal DMRS configuration or a reduced DMRS configuration for the target UE based on the estimated channel change,
wherein, in the normal DMRS configuration, a DMRS symbol is assigned to each time slot, while in the reduced DMRS configuration, a DMRS symbol is assigned to each subframe.

12. The apparatus according to claim 11, wherein in the reduced DMRS configuration, the assigned DMRS symbol is located at the middle of the subframe.

13. The apparatus according to claim 12, wherein the assigned DMRS symbol is located at a last symbol of a first time slot of the subframe.

14. The apparatus according to claim 12, wherein the assigned DMRS symbol is located at a first symbol of a second time slot of the subframe.

15. The apparatus according to claim 11, wherein the channel change estimating unit is configured to estimate channel change between a first time slot and a second time slot of the subframe in the normal DMRS configuration.

16. The apparatus according to claim 11, wherein the channel change estimating unit is configured to estimate channel change between a first subframe and a second subframe of two consecutive subframes in the reduced DMRS configuration.

17. The apparatus according claim 11, wherein the channel change estimating unit is configured to estimate channel change using one of channel matrix estimation, Doppler estimation, or UE speed estimation.

18. The apparatus according to claim 11, wherein the DMRS configuration selecting unit is configured to select the reduced DMRS configuration for subsequent uplink transmission if the estimated channel change is lower than a first predetermined threshold in case of currently using the normal DMRS configuration.

19. The apparatus according to claim 11, wherein the DMRS configuration selecting unit is configured to select the normal DMRS configuration for subsequent uplink transmission if the estimated channel change is higher than a second predetermined threshold in case of currently using the reduced DMRS configuration.

20. The apparatus according to claim 11, further comprising:
a DMRS configuration informing unit configured to indicate the selected DMRS configuration to the target UE through higher-level signaling so as to be used for subsequent uplink transmission.
